(19) United States
(12) Patent Application Publication
(10) Pub. No.: US 2026/0036723 A1
(43) Pub. Date: Feb. 5, 2026

(54) MEMBER FOR DISPLAY DEVICE AND DISPLAY DEVICE

(71) Applicant: DAI NIPPON PRINTING CO., LTD., Tokyo (JP)

(72) Inventors: Kiyohiro TAKACHI, Tokyo (JP); Atsuhiro KOBAYASHI, Tokyo (JP); Keisuke EBISU, Tokyo (JP)

(21) Appl. No.: 19/120,630

(22) PCT Filed: Oct. 13, 2023
(86) PCT No.: PCT/JP2023/037175

§ 371 Date: Aug. 11, 2025

(30) Foreign Application Priority Data
Oct. 14, 2022 (JP) 2022-165442

(51) Int. Cl. G02B 1/14; G06F 1/16

(52) U.S. Cl. CPC G02B 1/14; G06F 1/1616; G06F 1/1652; G06F 1/1656

(57) ABSTRACT

The present disclosure provides a member for a display device comprising a stacked body formed by stacking an impact absorbing layer and a hard coating layer, wherein, when measuring a tensile stress of the stacked body, a stress at which the hard coating layer breaks is regarded as a hard coating layer breaking strength, and an elongation at which the hard coating layer breaks is regarded as a hard coating layer breaking elongation, the hard coating layer breaking strength is 7 MPa or more, and the hard coating layer breaking elongation is 4% or more and 36% or less.

### TECHNICAL FIELD

The present disclosure relates to a member for a display device and a display device.

### BACKGROUND ART

In a display device, a glass or resin cover member is conventionally used for protecting the display device. This cover member protects the display device from impact and scratches, and it is required to have, for example, strength, impact resistance, and scratch resistance. The glass cover member has properties such as a high surface hardness so that it is hardly scuffed, and a high transparency, while the resin cover material has properties such as a lightweight and resistant to breakage. Also, in general, the thicker the cover member, the higher the function of protecting the display device from impact, and the material and thickness of the cover member are selected and used according to, for example, the weight, cost, and the size of the display device.

In recent years, flexible displays such as a foldable display, a rollable display, and a bendable display have been actively developed, and among them, the foldable displays, that is, display devices those can be folded have been developed.

In the display device that can be folded, the cover member must also bend in accordance with the movement of the display device, so the cover member that can be folded is applied. In the case of a resin cover member, colorless and transparent polyimide and polyamideimide films have been developed by devising the chemical structures (refer, for example, Patent Document 1). Also, in the case of a glass cover member, studies are being conducted on cover members that can be folded by thinning glass such as Ultra-Thin Glass (UTG) (for example, refer to Patent Document 2). Among the glasses, glass referred to as chemically strengthened glass has particularly high bending resistance, and the glass is not likely to be cracked by imposing an expanding stress on the glass surface so that the microscopic scratches occurred on the glass surface do not increase when bent.

### CITATION LIST

### Patent Documents

Patent Document 1: Japanese Patent Application Laid-Open (JP-A) No. 2019-137864
Patent Document 2: JP-A No. 2018-188335

### SUMMARY OF DISCLOSURE

### Technical Problem

Since glass has a higher elastic modulus than resin, the ability to protect the display device is higher than that of resin when they have the same thickness. Also, glass is highly optically transparent, making it possible to produce display devices with better visibility. Meanwhile, when the thickness of the glass is reduced, it will be easier to break, and the impact resistance will deteriorate dramatically. When the glass of a glass member is cracked by an impact from outside, not only the function to protect the display device is deteriorated, but also there is a risk of injuring the user's fingertip or the like with an arisen shard or a sharp edge.

In the glass substrate, in order to prevent the breakage of the glass substrate due to an impact from the outside world, an impact absorbing layer is provided on the outer surface of the glass substrate in some cases. In this case, in order to improve the chafing resistance, a hard coating layer is provided on the surface of the impact absorbing layer that is opposite side to the glass substrate.

When it is used for a flexible display, not only excellent impact resistance and chafing resistance, but also bending resistance is required to the stacked body, including an impact absorbing layer and a hard coating layer, disposed on the outer surface side of such glass substrate. However, it is extremely difficult to obtain a stacked body wherein these three properties are well balanced.

The present disclosure has been made in view of the above circumstances, and a main object of the present disclosure is to provide a member for a display device with good impact resistance, chafing resistance and bending resistance.

### Solution to Problem

In order to solve the problem, as the result of intensive studies, the inventors of the present disclosure found out the followings, thereby achieved the present invention. When measuring a tensile stress of the stacked body, the hard coating layer will break at first. And by setting the stress and elongation, at which the hard coating layer breaks, in a predetermined range, a member for a display device with good impact resistance, chafing resistance and bending resistance can be obtained.

That is, the present disclosure provides a member for a display device comprising a stacked body formed by stacking an impact absorbing layer and a hard coating layer, wherein, when measuring a tensile stress of the stacked body, a stress at which the hard coating layer breaks is regarded as a hard coating layer breaking strength, and an elongation at which the hard coating layer breaks is regarded as a hard coating layer breaking elongation, the hard coating layer breaking strength is 7 MPa or more, and the hard coating layer breaking elongation is 4% or more and 36% or less.

In the member for a display device in the present disclosure, the hard coating layer breaking elongation is preferably less than 30%.

Also, in the member for a display device in the present disclosure, a glass substrate having a thickness of 100 μm or less is preferably disposed on a surface of the impact absorbing layer that is opposite side to the hard coating layer.

Another embodiment of the present disclosure provides a display device comprising: a display panel; and the member for a display device described above disposed on an observer side of the display panel.

In the present disclosure, the display device is preferably foldable in view of exhibiting the effect.

### Advantageous Effects of Disclosure

The present disclosure exhibits an effect that a member for a display device with good impact resistance, chafing resistance and bending resistance can be provided.

### BRIEF DESCRIPTION OF DRAWINGS

FIG. 1 is a schematic cross-sectional view exemplifying a stacked body used in the present disclosure.

FIG. 2 is a schematic cross-sectional view exemplifying a member for a display device in the present disclosure.

FIG. 3 is a schematic cross-sectional view exemplifying a member for a display device in the present disclosure.

FIG. 4 is a schematic cross-sectional view exemplifying a member for a display device in the present disclosure.

FIG. 5 is a schematic cross-sectional view exemplifying a display device in the present disclosure.

FIG. 6 are schematic cross-sectional views explaining a bending resistance test in the present disclosure.

FIG. 7 is a graph summarizing the comprehensive evaluation results in Examples and Comparative Examples.

### DESCRIPTION OF EMBODIMENTS

Embodiments in the present disclosure are hereinafter explained with reference to, for example, drawings. However, the present disclosure is enforceable in a variety of different forms, and thus should not be taken as is limited to the contents described in the embodiments exemplified as below. Also, the drawings may show the features of the present disclosure such as width, thickness, and shape of each part schematically comparing to the actual form in order to explain the present disclosure more clearly in some cases; however, it is merely an example, and thus does not limit the interpretation of the present disclosure. Also, in the present descriptions and each drawing, for the factor same as that described in the figure already explained, the same reference sign is indicated and the detailed explanation thereof may be omitted.

In the present descriptions, in expressing an aspect wherein some member is disposed on the other member, when described as merely “on” or “below”, unless otherwise stated, it includes both of the following cases: a case wherein some member is disposed directly on or directly below the other member so as to be in contact with the other member, and a case wherein some member is disposed on the upper side or the lower side of the other member via yet another member. Also, in the present descriptions, on the occasion of expressing an aspect wherein some member is placed on the surface of the other member, when described as merely “on the surface side” or “on the surface”, unless otherwise stated, it includes both of the following cases: a case wherein some member is placed directly on or directly below the other member so as to be in contact with the other member, and a case wherein some member is placed on the upper side or the lower side of the other member via yet another member.

Also, in the present specification, a member referred to as “sheet” is included in “film”.

A member for a display device and a display device in the present disclosure is hereinafter described in detail.

### A. Member for Display Device

The member for a display device in the present disclosure comprises a stacked body formed by stacking an impact absorbing layer and a hard coating layer, wherein, when measuring a tensile stress of the stacked body, a stress at which the hard coating layer breaks is regarded as a hard coating layer breaking strength (hereinafter, may be referred as HC breaking strength), and an elongation at which the hard coating layer breaks is regarded as a hard coating layer breaking elongation (hereinafter, may be referred as HC breaking elongation), the HC breaking strength is 7 MPa or more, and the HC breaking elongation is 4% or more and 36% or less.

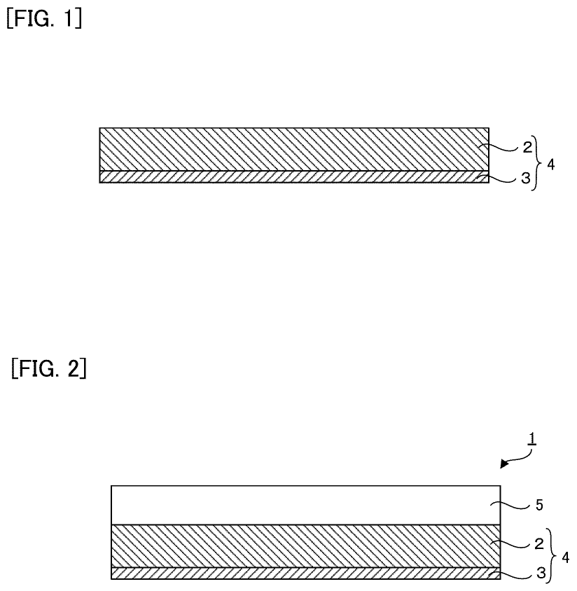

FIG. 1 is a schematic cross-sectional view illustrating an example of the stacked body used for a member for a display device in the present disclosure. As shown in FIG. 1, the stacked body 4 includes an impact absorbing layer 2, and a hard coating layer 3 disposed on one surface side of the impact absorbing layer 2. When the tensile stress of the stacked body 4 including the impact absorbing layer 2 and hard coating layer 3 is measured, the hard coating layer 3 breaks first, and in the present disclosure, the strength and elongation of stacked body 4 when the hard coating layer 3 breaks are in the predetermined ranges.

FIG. 2 exemplifies a member for a display device 1 in the present disclosure, and in the member for a display device 1, a stacked body 4 is disposed, and a glass substrate 5 is disposed on the surface of impact absorbing layer 2 of the stacked body 4 that is opposite side to the hard coating layer 3.

In the present disclosure, the HC breaking elongation being 4% or more and 36% or less is referred to as follows. When measuring the tensile stress by stretching the stacked body, both the hard coating layer and impact absorbing layer are stretched, but the hard coating layer, which is stiffer and thinner, breaks first. The HC breaking elongation means the elongation at which the hard coating layer breaks, and the stacked body in the present disclosure is characterized in that this elongation of the stacked body at which the hard coating layer breaks is 4% or more and 36% or less. In the member for a display device in the present disclosure, since the HC breaking elongation of the stacked body is in the above range, the stiffness of the hard coating layer is in the appropriate range so that a stacked body with good chafing resistance and bending resistance can be obtained.

That is, when the HC breaking elongation is less than 4%, it means that the hard coating layer is too stiff. For this reason, when the stacked body is bent, a large shear stress is applied to the hard coating layer at the bent portion, both in the outer bending and inner bending. As the result, there is a high possibility that cracks and wrinkles will occur in the hard coating layer, which will cause defects in the appearance when used as a folding type display device, for example.

Meanwhile, when the HC breaking elongation is over 36%, it means that the stiffness of the hard coating layer is not sufficient, and the surface is relatively soft so that the chafing resistance is low. For this reason, when the stacked body is used as a display device, there is a problem that the surface tends to be scratched easily during the use.

Also, in the stacked body used for the member for a display device in the present disclosure, the HC breaking strength of 7 MPa or more is similarly the strength (tensile stress of the stacked body) when the hard coating layer breaks, and it means the tensile stress of the impact absorbing layer at break. The stacked body in the present disclosure is characterized in that this tensile stress of the impact absorbing layer, at which the hard coating layer breaks, is 7 MPa or more.

Since the HC breaking strength of the stacked body is in the above range, which means that the impact absorbing layer is harder, and this can improve the impact resistance in a pen dropping test.

### 1. Properties of Stacked Body

The properties of the stacked body in the present disclosure are hereinafter described.

### (1) in Relation to HC Breaking Elongation

The lower limit of the HC breaking elongation of the stacked body in the present disclosure is 4% or more, may be 6% or more, and preferably 7% or more. Meanwhile, the upper limit is 36% or less, and preferably less than 30%. The specific range of the HC breaking elongation is 4% or more and 36% or less, may be 6% or more and 36% or less, and preferably 6% or more and less than 30%.

The method for measuring the HC breaking elongation is as follows.

Firstly, a test piece having a dumbbell shape (total length of 100 mm, standard length of 20 mm) is obtained by cutting the stacked body with a lever type cutting machine SDL-200 provided with a dumbbell shape No. 3 according to JIS (Dumbbell Co., Ltd.). The test piece is pulled by TENSILON Universal Material Testing Instrument at speed of 100 mm/minute. The test piece is irradiated with a LED light, the elongation when a crack (split) occurred only in the HC layer is regarded as “a” (mm), and the value obtained from the following formula is regarded as HC breaking elongation.

HC breaking elongation=(a/20)×100(%) (Formula)

In order to obtain the stacked body from the member for a display device, the stacked body is peeled off slowly from the edge surface of the stacked body while heating the stacked body with a dryer. When the film is likely to break off, the film is likely to be obtained easily by peeling slowly after cooling thereof once to a room temperature.

### (2) HC Breaking Strength

The lower limit of the HC breaking strength of the stacked body is 7 MPa or more, and preferably 10 MPa or more. Meanwhile, the upper limit is preferably 100 MPa or less, and particularly preferably 70 MPa or less. When the HC breaking strength is too high, the HC is hard and fragile so that the bending property deteriorates. As for the specific range, it is preferably 7 MPa or more and 70 MPa or less, and particularly preferably 10 MPa or more and 70 MPa or less.

For the method for measuring a HC breaking strength, the method similar to the method for measuring a HC breaking elongation described above can be used.

### (3) Young's Modulus of Stacked Body

In the present disclosure, in order to improve the impact resistance (pen dropping property), the Young's modulus of the stacked body is preferably 90 MPa or more, and particularly preferably 290 MPa or more. Meanwhile, the upper limit is preferably 3000 MPa or less.

When the value is below the above range, the stiffness of the impact absorbing layer is not sufficient so that the impact resistance (pen dropping property) may be reduced. Meanwhile, when the value is above the above range, there is a possibility that problems such as bending resistance may occur.

To measure the Young's modulus of the stacked body, a stress-strain curve is prepared when measuring the HC breaking elongation, and the strain when the load is 0.01 MPa is regarded as 0%, and the slope in the range of 0.5% to 1.0% is determined.

### (4) Thickness of Stacked Body

The thickness of the stacked body in the present disclosure is preferably 15 μm or more and 300 μm or less, and particularly preferably 40 μm or more and 200 μm or less. When the thickness is thinner than the above range, the impact resistance (pen dropping property) may be reduced, and when the thickness is thicker than the above range, properties such as bending resistance may be reduced.

### 2. Structure of Member for Display Device

The member for a display device in the present disclosure has only to include the stacked body described above, and a glass substrate is usually disposed on the impact absorbing layer side of the stacked body.

In the stacked body, the impact absorbing layer and hard coating layer have only to be disposed adjacently. In other words, the impact absorbing layer and hard coating layer may be in contact with each other, and may be adhered by, for example, an adhesive layer. In the present disclosure, it is preferable that they are disposed in contact with each other, taking into account that the hard coating layer is formed by an application method, and that an adhesive layer is not necessary.

Each constitution of the member for a display device in the present disclosure is hereinafter described.

### (1) Stacked Body

The stacked body used in the present disclosure includes an impact absorbing layer and a hard coating layer.

### a) Impact Absorbing Layer

The material of the impact absorbing layer used for the stacked body is not particularly limited as long as the and HC breaking elongation and HC breaking strength described above can be exhibited when the impact absorbing layer is stacked with the hard coating layer to obtain a stacked body.

Specifically, examples thereof may include urethane based resins, and polyethylene terephthalate based resins. Among them, urethane based resins are preferable. This is because the use of the urethane based resin makes it easy to adjust the HC breaking strength to be in the above range.

The urethane based resins are resins including urethane bonding. Examples of the urethane based resin may include a cured product of an ionizing radiation curable urethane based resin composition, and a cured product of a thermosetting urethane based resin composition. Among these, cured product of an ionizing radiation curable urethane based resin composition is preferable from the viewpoint of obtaining high hardness, high curing speed, and excellent mass production ability.

The thermosetting urethane based resin composition may include, for example, polyol compounds and isocyanate compounds. The polyol compounds and isocyanate compounds may be any one of monomers, oligomers, and prepolymers.

The ionizing radiation curable urethane based resin composition may include, for example, urethane (meth)acrylate. The urethane (meth)acrylate may be any one of monomers, oligomers, and prepolymers.

The number of the (meth)acryloyl group (number of functional groups) in the urethane (meth)acrylate is preferably, for example, 2 or more and 4 or less, and more preferably 2 or more and 3 or less. When the number of the (meth)acryloyl groups in the urethane (meth)acrylate is low, the hardness may be low. Also, when the number of the (meth)acryloyl groups in the urethane (meth)acrylate is high, the cure shrinkage increases, and the impact absorbing layer is curled, or there is a risk of cracking the impact absorbing layer when it is bent.

Incidentally, “(meth)acrylate” includes both of “acrylate” and “methacrylate”, and (meth)acryloyl group” includes both of “acryloyl group” and “methacryloyl group”.

The weight average molecular weight of the urethane (meth)acrylate is preferably, for example, 1,500 or more 20,000 or less, and more preferably 2,000 or more 15,000 or less. When the weight average molecular weight of the urethane (meth)acrylate is too low, impact resistance may be reduced. Also, when the weight average molecular weight of the urethane (meth)acrylate is too high, the viscosity of the ionizing radiation curable urethane based resin composition will increase and the coating property may deteriorate. Incidentally, the weight average molecular weight of the urethane (meth)acrylate is a value measured, by gel permeation chromatography (GPC), in terms of polystyrene.

When the urethane based resin is a cured product of an ionizing radiation curable urethane based resin composition, and the ionizing radiation curable urethane based resin composition includes the urethane (meth)acrylate, the urethane based resin includes a repeating unit having a structure derived from urethane (meth) acrylate. Examples of the repeating unit having a structure derived from urethane (meth) acrylate may include a structure represented by the following general formula (1), (2), (3) or (4).

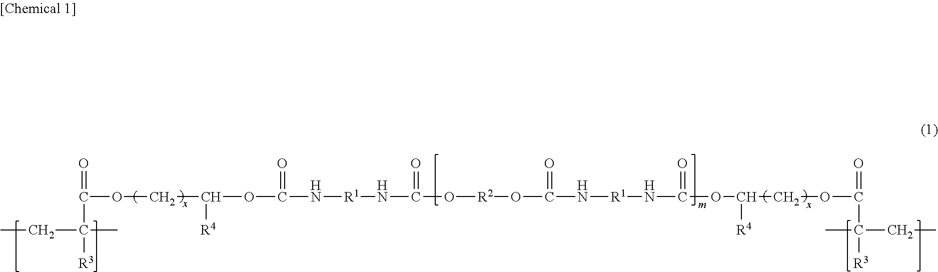

In the general formula (1), R¹ represents a branched-chain alkyl group; R² represents a branched-chain alkyl group or saturated cyclic aliphatic group; R³ represents a hydrogen atom or a methyl group; R⁴ represents a hydrogen atom, a methyl group, or an ethyl group; “m” represents an integer of 0 or more; and “x” represent an integer of 0 or more and 3 or less.

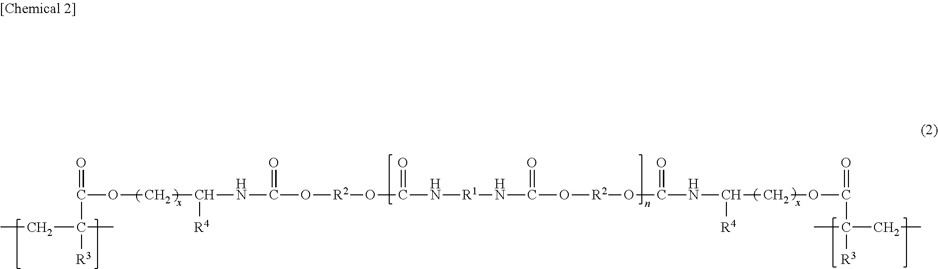

In the general formula (2), R¹ represents a branched-chain alkyl group; R² represents a branched-chain alkyl group or saturated cyclic aliphatic group; R³ represents a hydrogen atom or a methyl group; R⁴ represents a hydrogen atom, a methyl group, or an ethyl group; “n” represents an integer of 1 or more; and “x” represent an integer of 0 or more and 3 or less.

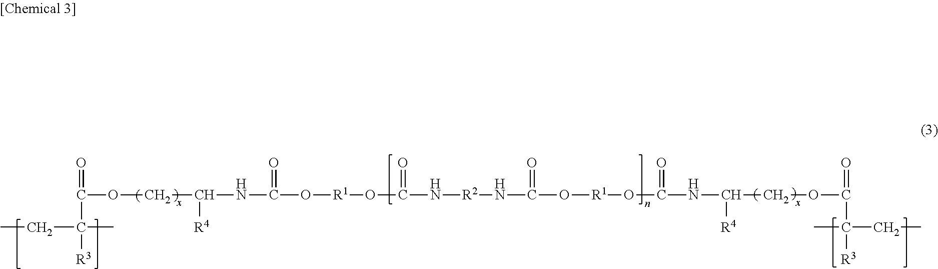

In the general formula (3), R¹ represents a branched-chain alkyl group; R² represents a branched-chain alkyl group or saturated cyclic aliphatic group; R³ represents a hydrogen atom or a methyl group; R⁴ represents a hydrogen atom, a methyl group, or an ethyl group; “m” represents an integer of 0 or more; and “x” represent an integer of 0 or more and 3 or less.

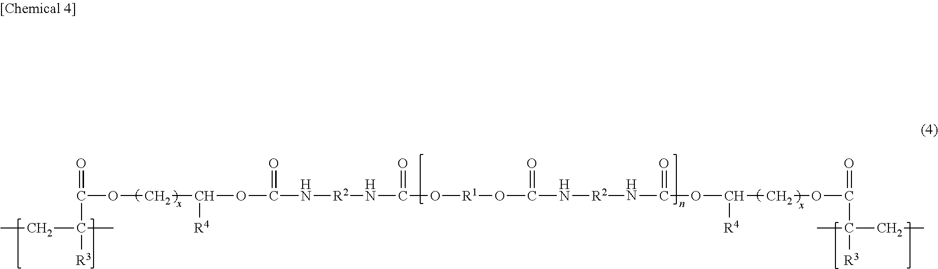

In the general formula (4), R¹ represents a branched-chain alkyl group; R² represents a branched-chain alkyl group or saturated cyclic aliphatic group; R³ represents a hydrogen atom or a methyl group; R⁴ represents a hydrogen atom, a methyl group, or an ethyl group; “n” represents an integer of 1 or more; and “x” represent an integer of 0 or more and 3 or less.

Incidentally, the structure of polymer chain (repeating unit) forming the resin constituting the impact absorbing layer can be determined by, for example, pyrolysis gas chromatography mass spectrometry (GC-MS) and Fourier transform infrared spectroscopy analysis (FT-IR) of the impact absorbing layer. In particular, pyrolysis GC-MS is useful because it can detect monomeric units included in the impact absorbing layer as monomer components.

The impact absorbing layer may include, for example, ultraviolet absorbers, spectral transmittance adjusters, antifoulants, inorganic particles, leveling agents, and polymerization inhibitors, as necessary.

The Young's modulus of the impact absorbing layer in the present disclosure is not particularly limited as long as the HC breaking strength in the predetermined range described above can be obtained, and excellent impact resistance (pen dropping properties) can be obtained. Specifically, it is preferably 50 MPa or more, and particularly preferably 100 MPa or more. Meanwhile, the upper limit is preferably 3000 MPa or less, more preferably 900 MPa or less, and particularly preferably 300 MPa or less. The range is preferably 50 MPa or more and 3000 MPa or less, and preferably 100 MPa or more and 900 MPa or less.

The method for measuring Young's modulus of the impact absorbing layer is similar to the method for measuring Young's modulus of the stacked body, so the description here is omitted. Incidentally, the Young's modulus of the stacked body is almost the same as the Young's modulus of the impact absorbing layer alone.

The thickness of the impact absorbing layer in the present disclosure varies according to the Young's modulus of the impact absorbing layer, and is not particularly limited as long as the HC breaking strength in the predetermined range described above can be obtained, and excellent impact resistance (pen dropping properties) can be obtained.

Specifically, the lower limit is preferably 10 μm or more, more preferably 30 μm or more, and particularly preferably 40 μm or more. Meanwhile, the upper limit is preferably 300 μm or less, and more preferably 200 μm or less.

The preferable range is preferably 10 μm or more and 300 μm or less, and more preferably 30 μm or more and 200 μm or less.

Here, the thickness of the impact absorbing layer may be the average value of the thickness of arbitrary 10 points obtained by measuring from the thickness directional cross-section of the member for a display device by observing with a transmission electron microscope (TEM), a scanning electron microscope (SEM) or a scanning transmission electron microscope (STEM). Incidentally, the same may be applied to the measuring methods of the thickness of other layers included in the member for a display device.

The impact absorbing layer in the present disclosure preferably has a predetermined transparency. Specifically, the total light transmittance of the impact absorbing layer is preferably, for example, 85% or more, more preferably 88% or more, and further preferably 90% or more. When the total light transmittance is high as described above, the member for a display device may have good transparency.

Here, the total light transmittance of the impact absorbing layer may be measured according to JIS K7361-1, and may be measure with, for example, a haze meter HM150 from Murakami Color Research Laboratory Co., Ltd.

Also, the haze of the impact absorbing layer is preferably, for example 5% or less, more preferably 2% or less, and further preferably 1% or less. When the haze is low as described above, the member for a display device may have good transparency.

Here, the haze of the impact absorbing layer may be measured according to JIS K-7136, and may be measure with, for example, a haze meter HM150 from Murakami Color Research Laboratory Co., Ltd.

As the impact absorbing layer, for example, a film shaped impact absorbing layer may be used. Also, for example, the impact absorbing layer may be formed by coating a supporting body with a composition for an impact absorbing layer.

### b) Hard Coating Layer

The stacked body in the present disclosure includes a hard coating layer disposed on the surface of the impact absorbing layer. The hard coating layer is a member configured to enhance the surface hardness. By disposing the hard coating layer, chafing resistance can be improved. Specifically, on the surface including the hard coating layer, the stacked body in the present disclosure preferably exhibits a hardness of “H” or more, when the pencil hardness test according to JIS K 5600-5-4 (1999) is carried out.

The material for forming the hard coating layer in the present disclosure is not particularly limited as long as the HC breaking strength and HC breaking elongation of the stacked body in the present disclosure in the range described above can be obtained.

The hard coating layer includes a cured product of a resin composition including a polymerizable compound. The cured product of a resin composition including a polymerizable compound may be obtained by carrying out a polymerization reaction of a polymerizable compound, by a known method, using a polymerization initiator if necessary.

The polymerizable compound includes at least one polymerizable functional group in the molecule. As the polymerizable compound, for example, at least one kind of radical polymerizable compound and cation polymerizable compound may be used.

The radical polymerizable compound is a compound including a radical polymerizable group. The radical polymerizable group included in the radical polymerizable compound may be any functional group capable of generating a radical polymerization reaction, and is not particularly limited; and examples thereof may include a group including a carbon-carbon unsaturated double bond, and specific examples thereof may include a vinyl group and a (meth) acryloyl group. Incidentally, when the radical polymerizable compound includes two or more radical polymerizable groups, these radical polymerizable groups may be the same, and may be different from each other.

The number of radical polymerizable groups included in one molecule of the radical polymerizable compound is preferably two or more, and more preferably three or more, from the viewpoint of improving the hardness of the hard coating layer.

Incidentally, in the present description, the (meth)acryloyl refers to each of an acryloyl and a methacryloyl respectively.

The cation polymerizable compound is a compound including a cation polymerizable group. The cation polymerizable group included in the cation polymerizable compound may be a functional group capable of generating a cation polymerization reaction, and is not particularly limited; and examples thereof may include an epoxy group, an oxetanyl group, and a vinyl ether group. Incidentally, when the cation polymerizable compound includes two or more cation polymerizable groups, these cation polymerizable groups may be the same, and may be different from each other.

The number of the cation polymerizable groups included in one molecule of the cation polymerizable compound is preferably two or more, and further preferably three or more, from the viewpoint of improving hardness of the hard coating layer.

The resin composition may include a polymerization initiator if necessary. As the polymerization initiator, a radical polymerization initiator, a cation polymerization initiator, and a radical and cation polymerization initiator may be appropriately selected and used. These polymerization initiators are decomposed by at least one type of light irradiation and heating to generate radicals or cations to cause radical polymerization and cation polymerization to proceed. Incidentally, all of the polymerization initiator may be decomposed and may not be left in the hard coating layer, in some cases.

In the present disclosure, in order to increase the HC breaking elongation, for example, by using a compound including flexible ethylene oxide as a part of the material of the hard coating layer, for example, as the polymerizable compound, film forming property and close adhesiveness can be imparted to the hard coating layer so that the hard coating layer breaking elongation can be improved. Examples of such compound may include poly(oxyalkylene) alkyl ether compounds including a (meth)acrylic group. Examples of the poly(oxyalkylene) alkyl ether compound including a (meth)acrylic group may include Light Ester 3EG-A, Light Ester 4EG-A, and Light Ester 9EG-A (each from Kyoeisha Chemical Co., Ltd.); A-200 and A-400 (each from Shin-Nakamura Chemical Co. Ltd.); and MPE400A and MPE550A (each from Osaka Organic Chemical Industry, Ltd.).

The thickness of the hard coating layer is not particularly limited as long as the HC breaking elongation, of the stacked body in the present disclosure, in the ranges described above can be obtained. As for the specific thickness, it is preferably, for example, 1 μm or more and 35 μm or less, more preferably 2 μm or more and 25 μm or less, and particularly preferably 3 μm or more and 25 μm or less. When the thickness of the hard coating layer is in the above range, the HC breaking elongation of the stacked body in the present disclosure in the above range can be easily achieved.

The hard coating layer may further include an additive if necessary. The additive is appropriately selected according to the function imparted to the hard coating layer, and is not particularly limited. Examples thereof may include fillers, ultraviolet absorbers, infrared absorbers, antifoulants, antiglare agents, antistatic agents, leveling agents, surfactants, easy lubricants, various sensitizers, flame retardants, adhesive imparting agents, polymerization inhibitors, antioxidants, light stabilizers and surface modifiers.

Examples of the method for forming a hard coating layer may include a method wherein the substrate layer is coated with a curable resin composition for a hard coating layer including the polymerizable compound, and cured.

The Martens hardness (HM) of the hard coating layer in the present disclosure, at the middle of the cross-section of the hard coating layer, is preferably 50 MPa or more, and further preferably 100 MPa or more. The “Martens hardness” in the present specification is a hardness when an indenter is pushed-in for 500 nm by the hardness measurement by the nanoindentation method. The measurement of the Martens hardness by the nanoindentation method is carried out, to an optical film cut out to the size of 30 mm×30 mm, using “TI950 TriboIndenter” from Bruker Corporation. In other words, a Berkovich indenter (a triangular pyramid, such as TI-0039 from Bruker Corporation) as the indenter is pushed-in vertically for 500 nm onto the cross-section of the hard coating layer under the following measurement conditions. Here, in order to avoid an influence of the side edge of the impact absorbing layer or hard coating layer, the Berkovich indenter shall be pushed-in onto a portion of the hard coating layer which is 500 nm away from the interface between the impact absorbing layer and hard coating layer toward the center side of the hard coating layer, and 500 nm or more away from both side edges of the hard coating layer respectively toward the center side of the hard coating layer. Then, after relieving the remaining stress by maintaining constant, the load is unloaded, the maximum load after relieving is measured, and by using the maximum load Pmax and the depression area A having a depth of 500 nm, the Martens hardness is calculated by Pmax/A. The Martens hardness is an arithmetic average value of the value obtained by measuring at ten places. Incidentally, when a value deviating ±20% or more from the arithmetic average value is included in the measured values, that measured value is excluded, and the measurement is carried out for one more time. Whether the value deviating ±20% or more from the arithmetic average value exists in the measured value, or not is determined by checking whether the value (%) obtained by (A−B)/B×100, when the measured value is regarded as A and the arithmetic average value is regarded as B, is +20% or more, or not.

### (Measurement Conditions)

Controlling method: displacement controlling
Loading speed: 10 nm/second
Retention time: 5 seconds
Unloading speed: 10 nm/second
Measurement temperature: 23±5° C.
Measurement humidity: 30% to 70%

### (2) Glass Substrate

In the member for a display device in the present disclosure, a glass substrate having a thickness of 100 μm or less is preferably disposed and used on the surface of the impact absorbing layer of the stacked body that is opposite side to the hard coating layer.

The glass constituting the glass substrate is not particularly limited, and among them, it is preferably a chemically strengthened glass. The chemically strengthened glass is preferable since it has excellent mechanical strength and may be made thin accordingly. The chemically strengthened glass is typically a glass wherein mechanical properties are strengthened by a chemical method by partially exchanging ionic species, such as by replacing sodium with potassium, in the vicinity of the surface of glass, and includes a compressive stress layer on the surface.

Examples of the glass constituting the chemically strengthened glass substrate may include aluminosilicate glass, soda-lime glass, borosilicate glass, lead glass, alkali barium glass, and aluminoborosilicate glass.

Examples of the commercial products of the chemically strengthened glass substrate may include Gorilla Glass from Corning Incorporated, and Dragontrail from AGC Inc. Also, as the chemically strengthened glass substrate, for example, those described in Japanese Patent Application Laid-Open (JP-A) No. 2019-194143 may be used.

The thickness of the glass substrate is 100 μm or less, preferably 15 μm or more and 100 μm or less, more preferably 20 μm or more and 90 μm or less, and further preferably 25 μm or more and 80 μm or less. When the thickness of the glass substrate is thin as in the above range, excellent flexibility may be obtained, and at the same time, sufficient hardness may be obtained. It is also possible to suppress curling of the member for a display device. Furthermore, it is preferable in terms of reducing the weight of the member for a display device.

### (3) Other Constitutions

In addition to the respective layers described above, the member for a display device in the present disclosure may include other layers as required. Examples of the other layer may include a primer layer, a resin layer, and a decorative layer.

### a) Primer Layer

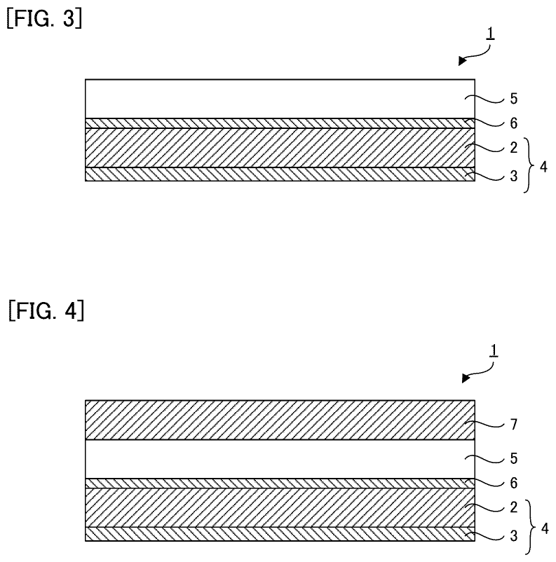

As shown in FIG. 3 for example, the member for a display device in the present disclosure may include a primer layer 6 between the glass substrate 5 and impact absorbing layer 2. By the primer layer, close adhesiveness between the glass substrate and impact absorbing layer may be improved.

The material of the primer layer is not particularly limited as long as it is a material capable of improving the close adhesiveness between the glass substrate and impact absorbing layer, and examples thereof may include resins. Examples of the resin may include (meth)acrylic resins, urethane resins, (meth)acrylic-urethane copolymers, vinyl chloride-vinyl acetate copolymer resins, polyesters, butyral resins, chlorinated polypropylene, chlorinated polyethylene, epoxy resins, and silicone resins. One type of these resins may be used alone, and two types or more may be used in a combination.

The thickness of the primer layer may be any thickness capable of improving the close adhesiveness between the glass substrate and impact absorbing layer, and may be, for example, 0.1 μm or more and 10 μm or less, and preferably 0.2 μm or more and 5 μm or less.

Examples of a method for forming a primer layer may include a method wherein the glass substrate is coated with a composition for a primer layer. Examples of the method for applying may include a general coating method such as a gravure coating method, a gravure reverse coating method, a gravure offset coating method, a spin coating method, a roll coating method, a reverse roll coating method, a blade coating method, a dip coating method, and a screen printing method. Also, a transfer method may also be used as a method for forming a primer layer.

### b) Resin Layer

As shown in FIG. 4 for example, the member for a display device in the present disclosure may include a resin layer 7 on the surface of the glass substrate 5 that is opposite side to the impact absorbing layer 2. When an impact is applied to the member for a display device, the impact may be absorbed not only by the impact absorbing layer but also by the resin layer so that the glass substrate can be suppressed from being cracked, and the impact resistance can be improved.

The resin included in the resin layer is not particularly limited as long as it is a resin capable of absorbing an impact, and examples thereof may include urethane resins, epoxy resins, polyimides, polyamideimides, acrylic resins, and triacetyl cellulose (TAC). One type of these resins may be used alone, and two types or more may be used in a combination.

The resin layer may further include an additive if necessary. Examples of the additives may include ultraviolet absorbers.

The thickness of the resin layer may be any thickness capable of absorbing an impact, and is preferably, for example, 5 μm or more and 60 μm or less, more preferably 10 μm or more and 50 μm or less, and further preferably 15 μm or more and 40 μm or less.

The method for forming the resin layer may be similar to the method for forming an impact absorbing layer described above.

### c) Decorative Layer

The member for a display device in the present disclosure may include a decorative layer between the glass substrate and resin layer, or on the surface of the glass substrate that is opposite to the resin layer.

The decorative layer includes a colorant and a binder resin. The binder resin included in the decorative layer is not particularly limited, and the resins used for common decorative layers may be used. Also, the colorant included in the decorative layer is not particularly limited, and known colorants used for common decorative layers can be used.

The decorative layer is usually disposed on a part of the glass substrate. Also, the decorative layer may have a patterned shape.

The thickness of the decorative layer is not particularly limited, and it may be, for example, 5 μm or more and 40 μm or less.

### 3. Properties of Member for Display Device

The total light transmittance of the member for a display device in the present disclosure is preferably, for example, 80% or more, more preferably 85% or more, and further preferably 88% or more. When the total light transmittance is high as described above, the member for a display device may have good transparency.

Here, the total light transmittance of the member for a display device may be measured according to JIS K7361-1, and may be measure with, for example, a haze meter HM150 from Murakami Color Research Laboratory Co., Ltd.

The haze of the member for a display device in the present disclosure is preferably, for example, 2.0% or less, more preferably 1.5% or less, and further preferably 1.0% or less.

When the haze is low as described above, the member for a display device may have good transparency.

Here, the haze of the member for a display device may be measured according to JIS K-7136, and may be measure with, for example, a haze meter HM150 from Murakami Color Research Laboratory Co., Ltd.

### 4. Use Application of Member for Display Device

The member for a display device in the present disclosure may be used as a member disposed on the observer side than the display panel in a display device. The member for a display device in the present disclosure may be used for a member for a display device such as smart phones, tablet terminals, wearable terminals, personal computers, televisions, digital signages, public information displays (PIDs), and car mounted displays. Among the above, the member for a display device in the present disclosure may be preferably used for a member for a flexible display such as a foldable display, a rollable display, and a bendable display; and more preferably used for a foldable display.

In the member for a display device in the present disclosure, the outermost surface when the member for a display device is disposed on the surface of a display device is preferably the hard coating layer side surface.

The method for disposing the member for a display device in the present disclosure on the surface of the display device is not particularly limited, and examples thereof may include a method via an adhesive layer. As an adhesive layer, a known adhesive layer used for adhering a member for a display device may be used.

### B. Display Device

The display device in the present disclosure comprises: a display panel, and the member for a display device described above disposed on an observer side of the display panel.

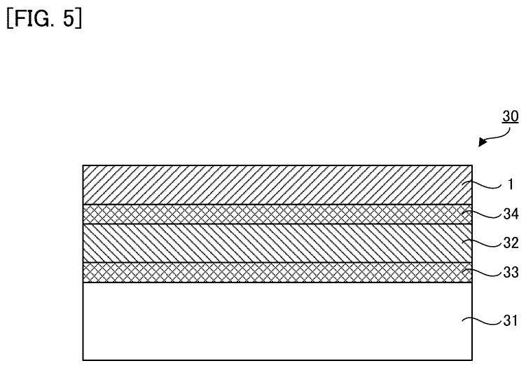

FIG. 5 is a schematic cross-sectional view illustrating an example of a display device in the present disclosure. As shown in FIG. 5, the display device 30 comprises a display panel 31, a touch-sensitive panel member 32, and the member for a display device 1 disposed on an observer side of the display panel 31 and touch-sensitive panel member 32. In the display device 30, the member for a display device 1 is used as a member to be disposed on the surface of the display device 30, and an adhesive layer 34 is disposed between the member for a display device 1 and the touch-sensitive panel member 32. Also, an adhesive layer 33 is also disposed between the display panel 31 and the touch-sensitive panel member 32.

The member for a display device in the present disclosure may be similar to the member for a display device described above.

Examples of the display panel in the present disclosure may include a display panel used for a display device such as a liquid crystal display device, an organic EL display device, and a LED display device.

The display device in the present disclosure may include a touch-sensitive panel member between the display panel and the member for a display device.

The display device in the present disclosure is preferably a flexible display. Among them, the display device in the present disclosure is preferably foldable. That is, the display device in the present disclosure is more preferably a foldable display. Since the display device in the present disclosure includes the member for a display device described above, it has excellent bending resistance, and is suitable as a flexible display, and further a foldable display.

Incidentally, the present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### EXAMPLES

The present disclosure is hereinafter explained in further details with reference to Examples and Comparative Examples.

### Example 1

### <Preparation of Impact Absorbing Layer (SA1)>

As a releasing film, a polyethylene terephthalate substrate with a thickness of 100 μm (product name: “Cosmo Shine (registered trademark) A4160”, from Toyobo Co., Ltd.) was prepared. The untreated surface side of the polyethylene terephthalate substrate was coated with the following composition for an impact absorbing layer 1, by a bar coater, and a coating film was formed so that the thickness after curing was 80 μm. An impact absorbing layer was formed by curing the coating film by irradiating ultraviolet rays, in air, with an ultraviolet ray irradiation device (light source H bulb from Fusion UV Systems Japan K.K.) so that the integrated light amount was 500 mJ/cm².

### <Composition for Impact Absorbing Layer 1>

Urethane acrylate (product name “UV-3310B” from Mitsubishi Chemical Corporation): 20 parts by mass
Urethane acrylate (product name “UV-3000B” from Mitsubishi Chemical Corporation): 20 parts by mass
Ethoxylated pentaerythritol tetraacrylate (product name “ATM-35E” from Shin-Nakamura Chemical Co. Ltd.): 20 parts by mass
Acryloylmorpholine (product name 4-Acryloylmorpholine by Tokyo Chemical Industry Co., Ltd.): 40 parts by mass
Polymerization initiator (product name “Omnirad184” from IGM Resins B.V.): 5 parts by mass

### <Preparation of Hard Coating Layer (HC1)>

A coating film was formed by coating the surface of the impact absorbing layer formed above, that is opposite side to the releasing film, with the following resin composition for a hard coating layer 1 by a bar coater. Then, the solvent in the coating film was evaporated by heating this coating film for one minute at 70° C. A hard coating layer HC1 having a thickness of 6 μm was formed by curing the coating film by irradiating ultraviolet rays with an ultraviolet ray irradiation device (light source H bulb from Fusion UV Systems Japan K.K.) under the condition of an oxygen concentration of 100 ppm or less so that the integrated light amount was 200 mJ/cm². Thereby, a stacked body provided with a releasing film including a releasing film, an impact absorbing layer, and a hard coating layer in this order was obtained. By peeling the releasing film off, a stacked body including a hard coating layer and an impact absorbing layer was obtained.

### <Composition for Hard Coating Layer 1>

The values are solid content 100% conversion value, except for the solvent.
Urethane acrylate (product name “KUA-10H”, from KSM Corporation): 100 parts by mass
Polymerization initiator (1-hydroxycyclohexylphenyl ketone, product name “Omnirad184” from IGM Resins B.V.): 4 parts by mass
Leveling agent (product name “BYK-UV3535” from BYK-Chemie Japan Co., Ltd.): 0.5 parts by mass (solid content 100% conversion value)
Solvent “methyl isobutyl ketone”: 313.5 parts by mass

### Example 2

### <Preparation of Impact Absorbing Layer (SA1)>

An impact absorbing layer was formed on the releasing film in the same manner as in Example 1, except that the coating film was formed so that the thickness after curing was 100 μm.

### <Preparation of Hard Coating Layer (HC2)>

A hard coating layer HC2 was formed in the same manner as in Example 1, except that the surface of the impact absorbing layer formed above, that is opposite side to the releasing film, with the following resin composition for a hard coating layer 2 by a bar coater so that the thickness was 20 μm. Thereby, a stacked body provided with a releasing film including a releasing film, an impact absorbing layer, and a hard coating layer in this order was obtained. By peeling the releasing film off, a stacked body including a hard coating layer and an impact absorbing layer was obtained.

### <Composition for Hard Coating Layer 2>

Ethoxylated pentaerythritol tetraacrylate (product name “ATM-35E” from Shin-Nakamura Chemical Co., Ltd.): 95 parts by mass
Polyethylene glycol diacrylate (product name “A-200”, from Shin-Nakamura Chemical Co., Ltd.): 5 parts by mass
Polymerization initiator (product name “Omnirad184”, from, IGM Resins B.V.): 4 parts by mass
Leveling agent (product name “BYK-UV3535” from BYK-Chemie Japan Co., Ltd.): 0.5 parts by mass (solid content 100% conversion value)
Solvent “methyl isobutyl ketone”: 313.5 parts by mass

### Example 3

### <Preparation of Impact Absorbing Layer (SA1)>

An impact absorbing layer was formed on the releasing film in the same manner as in Example 2.

### <Preparation of Hard Coating Layer (HC2)>

A hard coating layer HC2 was formed on the surface of the impact absorbing layer that is opposite side to the releasing film in the same manner as in Example 2, except that the thickness was 15 μm. Thereby, a stacked body provided with a releasing film including a releasing film, an impact absorbing layer, and a hard coating layer in this order was obtained. By peeling the releasing film off, a stacked body including a hard coating layer and an impact absorbing layer was obtained.

### Example 4

### <Preparation of Impact Absorbing Layer (SA1)>

An impact absorbing layer was formed on the releasing film in the same manner as in Example 1.

### <Preparation of Hard Coating Layer (HC2)>

A hard coating layer HC2 was formed on the surface of the impact absorbing layer that is opposite side to the releasing film in the same manner as in Example 2, except that the thickness was 12 μm. Thereby, a stacked body provided with a releasing film including a releasing film, an impact absorbing layer, and a hard coating layer in this order was obtained. By peeling the releasing film off, a stacked body including a hard coating layer and an impact absorbing layer was obtained.

### Example 5

### <Preparation of Impact Absorbing Layer (SA1)>

An impact absorbing layer was formed on the releasing film in the same manner as in Example 1.

### <Preparation of Hard Coating Layer (HC2)>

A hard coating layer HC2 was formed on the surface of the impact absorbing layer that is opposite side to the releasing film in the same manner as in Example 2, except that the thickness was 6 μm. Thereby, a stacked body provided with a releasing film including a releasing film, an impact absorbing layer, and a hard coating layer in this order was obtained. By peeling the releasing film off, a stacked body including a hard coating layer and an impact absorbing layer was obtained.

### Example 6

### <Preparation of Impact Absorbing Layer (SA2)>

As a releasing film, a polyethylene terephthalate substrate with a thickness of 100 μm (product name: “Cosmo Shine (registered trademark) A4160” from Toyobo Co., Ltd.) was prepared. The untreated surface side of the polyethylene terephthalate substrate was coated with the following composition for an impact absorbing layer 2, by a bar coater, and a coating film was formed so that the thickness after curing was 80 μm. An impact absorbing layer was formed by curing the coating film by irradiating ultraviolet rays, in air, with an ultraviolet ray irradiation device (light source H bulb from Fusion UV Systems Japan K.K.) so that the integrated light amount was 500 mJ/cm².

### <Composition for Impact Absorbing Layer 2>

Urethane acrylate (product name “UV-3310B” from Mitsubishi Chemical Corporation): 30 parts by mass
Urethane acrylate (product name “UV-6630B” from Mitsubishi Chemical Corporation): 10 parts by mass
Mixture of pentaerythritol triacrylate and pentaerythritol tetraacrylate (product name “PET-30” from Nippon Kayaku Co., Ltd.): 20 parts by mass
Acryloylmorpholine (product name “4-acryloylmorpholine”, from Tokyo Chemical Industry Co., Ltd.): 20 parts by mass
N-hydroxyethyl acrylamide (product name “N-(2-Hydroxyehtyl) acrylamide”, from by KJ Chemicals Corporation): 20 parts by mass
Polymerization initiator (product name “Omnirad184”, from, IGM Resins B.V.): 5 parts by mass

### <Preparation of Hard Coating Layer (HC2)>

A hard coating layer HC2 was formed on the surface of the impact absorbing layer that is opposite side to the releasing film in the same manner as in Example 5. Thereby, a stacked body provided with a releasing film including a releasing film, an impact absorbing layer, and a hard coating layer in this order was obtained. By peeling the releasing film off, a stacked body including a hard coating layer and an impact absorbing layer was obtained.

### Example 7

### <Preparation of Impact Absorbing Layer (SA1)>

An impact absorbing layer was formed on the releasing film in the same manner as in Example 1.

### <Preparation of Hard Coating Layer (HC2)>

A hard coating layer HC2 was formed on the surface of the impact absorbing layer that is opposite side to the releasing film in the same manner as in Example 2, except that the thickness was 4 μm. Thereby, a stacked body provided with a releasing film including a releasing film, an impact absorbing layer, and a hard coating layer in this order was obtained. By peeling the releasing film off, a stacked body including a hard coating layer and an impact absorbing layer was obtained.

### Example 8

### <Preparation of Impact Absorbing Layer (SA3)>

As a releasing film, a polyethylene terephthalate substrate with a thickness of 100 μm (product name: “Cosmo Shine (registered trademark) A4160” from Toyobo Co., Ltd.) was prepared. The untreated surface side of the polyethylene terephthalate substrate was coated with the following composition for an impact absorbing layer 3, by a bar coater, and a coating film was formed so that the thickness after curing was 80 μm. An impact absorbing layer was produced by curing the coating film by irradiating ultraviolet rays, in air, with an ultraviolet ray irradiation device (light source H bulb from Fusion UV Systems Japan K.K.) so that the integrated light amount was 500 mJ/cm².

### <Composition for Impact Absorbing Layer 3>

Urethane acrylate (product name “UV-3310B” from Mitsubishi Chemical Corporation): 10 parts by mass
Urethane acrylate (product name “UV-3000B” from Mitsubishi Chemical Corporation): 30 parts by mass
Mixture of pentaerythritol triacrylate and pentaerythritol tetraacrylate (product name “PET-30”, from Nippon Kayaku Co., Ltd.): 20 parts by mass
Acryloylmorpholine (product name “4-acryloylmorpholine”, from Tokyo Chemical Industry Co., Ltd.): 30 parts by mass
N-hydroxyethyl acrylamide (product name “N-(2-hydroxyehtyl) acrylamide”, from by KJ Chemicals Corporation): 10 parts by mass
Polymerization initiator (product name “Omnirad184” from IGM Resins B.V.): 5 parts by mass

### <Preparation of Hard Coating Layer (HC2)>

A hard coating layer HC2 was formed on the surface of the impact absorbing layer that is opposite side to the releasing film in the same manner as in Example 5. Thereby, a stacked body provided with a releasing film including a releasing film, an impact absorbing layer, and a hard coating layer in this order was obtained. By peeling the releasing film off, a stacked body including a hard coating layer and an impact absorbing layer was obtained.

### Example 9

### <Preparation of Impact Absorbing Layer (SA3)>

An impact absorbing layer was formed in the same manner as in Example 8, except that the coating film was formed so that the thickness after curing was 100 μm.

### <Preparation of Hard Coating Layer (HC1)>

A hard coating layer HC1 was formed on the surface of the impact absorbing layer that is opposite side to the releasing film in the same manner as in Example 1. Thereby, a stacked body provided with a releasing film including a releasing film, an impact absorbing layer, and a hard coating layer in this order was obtained. By peeling the releasing film off, a stacked body including a hard coating layer and an impact absorbing layer was obtained.

### Example 10

### <Preparation of Impact Absorbing Layer (SA1)>

An impact absorbing layer was formed in the same manner as in Example 1, except that the coating film was formed so that the thickness after curing was 50 μm.

### <Preparation of Hard Coating Layer (HC3)>

A hard coating layer HC3 was formed in the same manner as in Example 1, except that the surface of the impact absorbing layer that is opposite side to the releasing film was coated with the following resin composition for a hard coating layer 3 by a bar coater. Thereby, a stacked body provided with a releasing film including a releasing film, an impact absorbing layer, and a hard coating layer in this order was obtained. By peeling the releasing film off, a stacked body including a hard coating layer and an impact absorbing layer was obtained.

### <Composition for Hard Coating Layer 3>

Ethoxylated pentaerythritol tetraacrylate (product name “ATM-35E” from Shin-Nakamura Chemical Co., Ltd.): 80 parts by mass
Polyethylene glycol diacrylate (product name “A-200”, from Shin-Nakamura Chemical Co., Ltd.): 20 parts by mass
Polymerization initiator (product name “Omnirad184”, from, IGM Resins B.V.): 4 parts by mass
Leveling agent (product name “BYK-UV3535” from BYK-Chemie Japan Co., Ltd.): 0.5 parts by mass (solid content 100% conversion value)
Solvent “methyl isobutyl ketone”: 313.5 parts by mass

### Example 11

### <Preparation of Impact Absorbing Layer (SA1)>

An impact absorbing layer was formed in the same manner as in Example 1, except that the coating film was formed so that the thickness after curing was 40 μm.

### <Preparation of Hard Coating Layer (HC3)>

A hard coating layer HC3 was formed on the surface of the impact absorbing layer that is opposite side to the releasing film, in the same manner as in Example 10. Thereby, a stacked body provided with a releasing film including a releasing film, an impact absorbing layer, and a hard coating layer in this order was obtained. By peeling the releasing film off, a stacked body including a hard coating layer and an impact absorbing layer was obtained.

### Example 12

### <Preparation of Impact Absorbing Layer (SA2)>

An impact absorbing layer was formed in the same manner as in Example 6, except that the coating film was formed so that the thickness after curing was 50 μm.

### <Preparation of Hard Coating Layer (HC3)>

A hard coating layer HC3 was formed on the surface of the impact absorbing layer that is opposite side to the releasing film, in the same manner as in Example 10. Thereby, a stacked body provided with a releasing film including a releasing film, an impact absorbing layer, and a hard coating layer in this order was obtained. By peeling the releasing film off, a stacked body including a hard coating layer and an impact absorbing layer was obtained.

### Comparative Example 1

### <Preparation of Impact Absorbing Layer (SA3)>

An impact absorbing layer was formed in the same manner as in Example 8, except that the coating film was formed so that the thickness after curing was 120 μm.

### <Preparation of Hard Coating Layer (HC1)>

A hard coating layer HC1 was formed on the surface of the impact absorbing layer that is opposite side to the releasing film in the same manner as in Example 1, except that the thickness was 12 μm. Thereby, a stacked body provided with a releasing film including a releasing film, an impact absorbing layer, and a hard coating layer in this order was obtained. By peeling the releasing film off, a stacked body including a hard coating layer and an impact absorbing layer was obtained.

### Comparative Example 2

### <Preparation of Impact Absorbing Layer (SA3)>

An impact absorbing layer was prepared in the same manner as in Example 8.

### <Preparation of Hard Coating Layer (HC1)>

A hard coating layer HC1 was formed on the surface of the impact absorbing layer that is opposite side to the releasing film, in the same manner as in Example 1. Thereby, a stacked body provided with a releasing film including a releasing film, an impact absorbing layer, and a hard coating layer in this order was obtained. By peeling the releasing film off, a stacked body including a hard coating layer and an impact absorbing layer was obtained.

### Comparative Example 3

### <Preparation of Impact Absorbing Layer (SA3)>

An impact absorbing layer was formed in the same manner as in Example 8, except that the coating film was formed so that the thickness after curing was 50 μm.

### <Preparation of Hard Coating Layer (HC4)>

A hard coating layer HC4 was formed in the same manner as in Example 1, except that the surface of the impact absorbing layer that is opposite side to the releasing film was coated with the following resin composition for a hard coating layer 4 by a bar coater. Thereby, a stacked body provided with a releasing film including a releasing film, an impact absorbing layer, and a hard coating layer in this order was obtained. By peeling the releasing film off, a stacked body including a hard coating layer and an impact absorbing layer was obtained.

### <Composition for Hard Coating Layer 4>

Ethoxylated pentaerythritol tetraacrylate (product name “ATM-35E” from Shin-Nakamura Chemical Co., Ltd.): 70 parts by mass
Ethoxylated dipentaerythritol polyacrylate (product name “A-DPH-12E” from Shin-Nakamura Chemical Co., Ltd.): 30 parts by mass
Polymerization initiator (product name “Omnirad184”, from, IGM Resins B.V.): 4 parts by mass
Leveling agent (product name “BYK-UV3535” from BYK-Chemie Japan Co., Ltd.): 0.5 parts by mass (solid content 100% conversion value)
Solvent “methyl isobutyl ketone”: 313.5 parts by mass

### Comparative Example 4

### <Preparation of Impact Absorbing Layer (SA1)>

An impact absorbing layer was prepared in the same manner as in Example 10.

### <Preparation of Hard Coating Layer (HC4)>

A hard coating layer HC4 was formed on the surface of the impact absorbing layer that is opposite side to the releasing film, in the same manner as in Comparative Example 3. Thereby, a stacked body provided with a releasing film including a releasing film, an impact absorbing layer, and a hard coating layer in this order was obtained. By peeling the releasing film off, a stacked body including a hard coating layer and an impact absorbing layer was obtained.

### [Measurement of Young's Modulus of Stacked Body and Impact Absorbing Layer]

Young's modulus of the stacked body and impact absorbing layer were measured by the method described in “A. Member for display device, 1. Properties of stacked body, (3) Young's modulus of stacked body” and “A. Member for display device, 2. Structure of member for a display device, (1) Stacked body, a) Impact absorbing layer”. The results are shown in Table 1.

### [Measurement of Hard Coating Layer Breaking Elongation and Hard Coating Layer Breaking Strength]

The hard coating layer breaking elongation and hard coating layer breaking strength were measured by the method described in “A. Member for display device, 1. Properties of stacked body, (1) In relation to HC breaking elongation”. The results are shown in Table 1.

### [Evaluation]

### (1) Impact Resistance Test (Pen Dropping Test)

An impact resistance test was carried out to the stacked body in Examples and Comparative Examples. An optical clear adhesive (OCA) film was adhered to the impact absorbing layer side surface of the stacked body, the separator was peeled off, and the OCA surface and a glass substrate (glass plate (product name “G-leaf” from Nippon Electric Glass Co., Ltd., having a thickness of 30 μm and a minimum bending radius of 3 mm) were adhered. Thereby, a member for a display device including a hard coating layer, an impact absorbing layer, an optical clear adhesive layer, and a glass substrate, in this order, was produced. The member for a display device was disposed on a stone platform. At this time, the member for a display device was disposed so that the glass substrate of the member for a display device faced the stone platform. Then, a ballpoint pen with a pen tip D of 0.7 mm and a weight of 5 g was dropped from a height of 10 cm. The condition of the portion on which the pen fell was observed with a tenfold magnifying glass, and the degree of damage was checked, and determined by the following evaluation criteria.

### Evaluation Criteria

A: no damage
B: with indentation marks
C: cracked or broken

### (2) Bending Resistance Test (Folding Resistance Test)

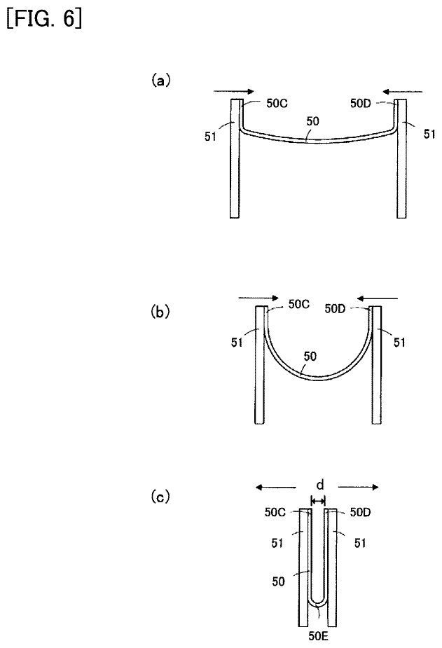

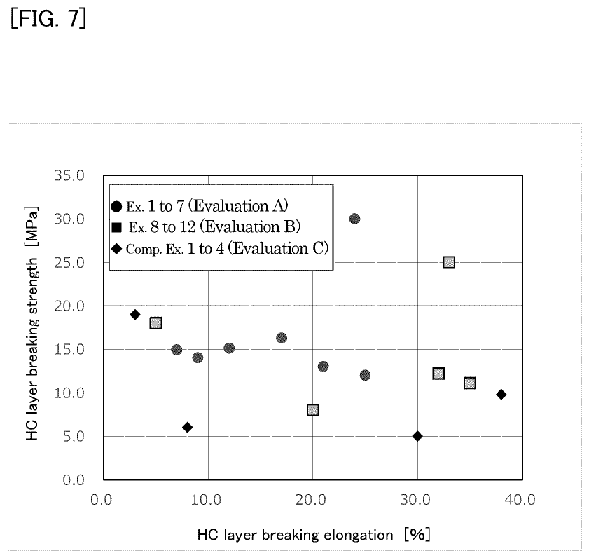

A continuous folding test was carried out to the stacked body in Examples and Comparative Examples to evaluate the folding resistance. Specifically, the stacked body was firstly cut out to be a measurement sample of a size of 20 mm×100 mm. Then, as shown in FIG. 6(a), two opposing short side portions 50C and 50D of the stacked body (measurement sample) 50 were respectively fixed by the parallelly disposed fixing portions 51 of a folding endurance test machine (for example, product name “U-shape Folding Teat Machine DLDMLH-FS” from Yuasa System Co., Ltd., compliant to IEC62715-6-1), and the stacked body (measurement sample) 50 was set so that the stacked body (measurement sample) 50 was folded into U-shape in the long side direction. Then, as shown in FIGS. 6(a) to (c), a continuous folding test wherein the stacked body (measurement sample) 50 was folded into 180° so that the minimum distance “d” between the two opposing short side portions 50C and 50D of the stacked body 50 was 7 mm, so that the hard coating layer side of the stacked body (measurement sample) 50 was on the outer side, was carried out for 200,000 times under the following conditions, and whether a deformation, a crack or a fracture has occurred in the bent portion 50E of the stacked body (measurement sample) 50, or not was checked. The continuous folding test was carried out under the room temperature conditions at room temperature (23° C.) and 50% relative humidity. Also, a continuous folding test wherein the stacked body (measurement sample) 50 was folded into 180° so that the minimum distance “d” between the two short side portions 50C and 50D of the stacked body 50 was 3 mm, so that the hard coating layer side of the stacked body (measurement sample) 50 was on the inner side, was carried out for 200,000 times. Further, a continuous folding test wherein the stacked body (measurement sample) 50 was folded into 180° so that the minimum distance “d” between the two short side portions 50C and 50D of the stacked body 50 was 6 mm, so that the hard coating layer side of the stacked body (measurement sample) 50 was on the inner side, was carried out for 200,000 times. The evaluation criteria were as follows. The results are shown in Table 2.

### 9 Evaluation Criteria

A: in the continuous folding test, no cracks or wrinkles occurred in the bent portion.
B: in the continuous folding test, although no cracks occurred, two or less wrinkles occurred in the bent portion.
C: in the continuous folding test, a crack or a wrinkle was clearly confirmed in the bent portion.

### (3) Chafing Resistance Test (Steel Wool Test)

The chafing resistance of the stacked body for a display device obtained in Examples and Comparative Examples was evaluated by the following test method. The results are shown in Table 2.

Using a color fastness rubbing tester AB-301 from Tester Sangyo Co., Ltd., a stacked body having a size of 5 cm×10 cm was fixed on a glass plate with cellophane tape (registered trademark) so that there is no bend or wrinkle. Then, using #0000 steel wool (Bonstar #0000 from Nippon Steel Wool Co., Ltd.), the steel wool was fixed to a 1 cm×1 cm jig, the hard coating layer side surface of the stacked body was rubbed under conditions of load of 1.5 kg/cm², traveling speed of 100 mm/second and traveling distance of 50 mm. The number of strokes until the peeling of the hard coating layer was determined, and evaluated based on the following evaluation criteria.

### Evaluation Criteria

A: 1000 strokes or more
B: 100 strokes of more and less than 1000 strokes
C: less than 100 strokes

As a comprehensive evaluation of the impact resistance test, bending resistance test, and chafing resistance test described above, the results were evaluated as “A” when the results for all of the three tests were evaluated as A, as “B” when the results for one or more tests were evaluated as B, and as “C” when the results for one or more tests were evaluated as C.

TABLE 1

| | | | | | Properties | | | |
|---|---|---|---|---|---|---|---|---|
| | Impact absorbing | | Hard coating | | SA | Stacked | HC | HC |
| | layer (SA) | | layer (HC) | | Young's | body | breaking | breaking |
| | | Thickness | | Thickness | modulus | Young's | elongation | strength |
| No. | Type | (μm) | Type | (μm) | (MPa) | modulus | (%) | (MPa) |
| Ex. 1 | SA1 | 80 | HC1 | 6 | 300 | 300 | 7.0 | 14.9 |
| Ex. 2 | SA1 | 100 | HC2 | 20 | 300 | 310 | 9.0 | 14.0 |
| Ex. 3 | SA1 | 100 | HC2 | 15 | 300 | 310 | 12.0 | 15.1 |
| Ex. 4 | SA1 | 80 | HC2 | 12 | 300 | 307 | 17.0 | 16.3 |
| Ex. 5 | SA1 | 80 | HC2 | 6 | 300 | 307 | 21.0 | 13.0 |
| Ex. 6 | SA2 | 80 | HC2 | 6 | 900 | 905 | 24.0 | 30.0 |
| Ex. 7 | SA1 | 80 | HC2 | 4 | 300 | 300 | 25.0 | 12.0 |
| Ex. 8 | SA3 | 80 | HC2 | 6 | 100 | 105 | 20.0 | 8.0 |
| Ex. 9 | SA3 | 100 | HC1 | 6 | 100 | 110 | 5.0 | 18.0 |
| Ex. 10 | SA1 | 50 | HC3 | 6 | 300 | 307 | 32.0 | 12.2 |
| Ex. 11 | SA1 | 40 | HC3 | 6 | 300 | 307 | 35.0 | 11.1 |
| Ex. 12 | SA2 | 50 | HC3 | 6 | 900 | 905 | 33.0 | 25.0 |
| Comp. Ex. 1 | SA3 | 120 | HC1 | 12 | 100 | 110 | 3.0 | 19.0 |
| Comp. Ex. 2 | SA3 | 80 | HC1 | 6 | 100 | 105 | 8.0 | 6.0 |
| Comp. Ex. 3 | SA3 | 50 | HC4 | 6 | 100 | 100 | 30.0 | 5.0 |
| Comp. Ex. 4 | SA1 | 50 | HC4 | 6 | 300 | 303 | 38.0 | 9.8 |

TABLE 2

| | Evaluation | | | | | |
|---|---|---|---|---|---|---|
| | | Bending | Bending | Bending | | |
| | Impact | resistance | resistance | resistance | Chafing | |
| | resistance | Outward bending | Inward bending | Inward bending | resistance test | |
| | test (pen | d = 7.0 mm | d = 3.0 mm | d = 6.0 mm | (steel wool | Comprehensive |
| No. | dropping test) | 200,000 times | 200,000 times | 200,000 times | test) [cycles] | evaluation |
| Ex. 1 | A | A | A | A | A | A |
| Ex. 2 | A | A | A | A | A | A |
| Ex. 3 | A | A | A | A | A | A |
| Ex. 4 | A | A | A | A | A | A |
| Ex. 5 | A | A | A | A | A | A |
| Ex. 6 | A | A | A | A | A | A |
| Ex. 7 | A | A | A | A | A | A |
| Ex. 8 | B | A | A | A | A | B |
| Ex. 9 | A | A | B | A | A | B |
| Ex. 10 | A | A | A | A | B | B |
| Ex. 11 | A | A | A | A | B | B |
| Ex. 12 | A | A | A | A | B | B |
| Comp. Ex. 1 | A | C | C | C | A | C |
| Comp. Ex. 2 | C | A | A | A | A | C |
| Comp. Ex. 3 | C | A | A | A | C | C |
| Comp. Ex. 4 | A | A | A | A | C | C |

FIG. 7 shows a graph wherein the results are plotted with the HC layer breaking elongation on the horizontal axis and the HC layer breaking strength on the vertical axis. As shown in Table 2 and FIG. 7, it was confirmed that the comprehensive evaluation of the impact resistance test, bending resistance test, and chafing resistance test of Examples 1 to 12 were better than that of Comparative Examples 1 to 4.

That is, in the present disclosure, the following inventions can be provided.

[1]

A member for a display device comprising a stacked body formed by stacking an impact absorbing layer and a hard coating layer, wherein,
when measuring a tensile stress of the stacked body, a stress at which the hard coating layer breaks is regarded as a hard coating layer breaking strength, and an elongation at which the hard coating layer breaks is regarded as a hard coating layer breaking elongation,
the hard coating layer breaking strength is 7 MPa or more, and the hard coating layer breaking elongation is 4% or more and 36% or less.
   [2]

The member for a display device according to [1], wherein the hard coating layer breaking elongation is less than 30%.

[3]

The member for a display device according to [1] or [2], wherein a glass substrate having a thickness of 100 μm or less is disposed on a surface of the impact absorbing layer that is opposite side to the hard coating layer.

[4]

A display device comprising:
a display panel; and
the member for a display device according to any one of [1] to [3] disposed on an observer side of the display panel.
   [5]

The display device according to [4], wherein the display device is foldable.

### REFERENCE SIGNS LIST

1: member for a display device
2: impact absorbing layer
3: hard coating layer
4: stacked body
5: glass substrate
6: primer layer
7: resin layer
30: display device
31: display panel
32: touch-sensitive panel member
33, 34: adhesive layer

1. A member for a display device comprising a stacked body formed by stacking an impact absorbing layer and a hard coating layer, wherein,
when measuring a tensile stress of the stacked body, a stress at which the hard coating layer breaks is regarded as a hard coating layer breaking strength, and an elongation at which the hard coating layer breaks is regarded as a hard coating layer breaking elongation,
the hard coating layer breaking strength is 7 MPa or more, and the hard coating layer breaking elongation is 4% or more and 36% or less.

2. The member for a display device according to claim 1, wherein the hard coating layer breaking elongation is less than 30%.

3. The member for a display device according to claim 1, wherein a glass substrate having a thickness of 100 μm or less is disposed on a surface of the impact absorbing layer that is opposite side to the hard coating layer.

4. A display device comprising:
a display panel; and
the member for a display device according to claim 1 disposed on an observer side of the display panel.

5. The display device according to claim 4, wherein the display device is foldable.
